(19) United States
(12) Patent Application Publication
(10) Pub. No.: US 2025/0289974 A1
(43) Pub. Date: Sep. 18, 2025

(54) COATING COMPOSITION AND PREPARATION FOR THE SAME

(71) Applicant: BASF SE, Ludwigshafen am Rhein (DE)

(72) Inventors: Zhen WEI, Shanghai (CN); Akiko TANABE, Yokkaichi (JP); Shuang Shuang XU, Shanghai (CN)

(21) Appl. No.: 18/862,735

(22) PCT Filed: Apr. 28, 2023
(86) PCT No.: PCT/EP2023/061397

§ 371 Date: Nov. 4, 2024

(30) Foreign Application Priority Data
May 6, 2022 (WO) PCT/CN2022/091188

(51) Int. Cl. C09D 133/14; C08K 5/17; C09D 5/02; C09D 7/65

(52) U.S. Cl. CPC C09D 133/14; C08K 5/17; C09D 5/024; C09D 7/65

(57) ABSTRACT

The present invention relates to a coating composition comprises binder containing polymer and/or copolymer of at least one acetoacetyl functional ethylenically unsaturated monomer, at least one of polyalkylenimines and/or polyetheramine polyol, and optionally at least one polyether amine, which shows good formaldehyde abatement, stain resistance and scrub resistance.

### FIELD OF THE INVENTION

The present disclosure relates to a coating composition comprises binder containing polymer and/or copolymer of at least one acetoacetyl functional ethylenically unsaturated monomer, at least one of polyalkylenimines and/or polyetheramine polyol, and optionally at least one polyether amine; and the preparation of the coating composition.

### BACKGROUND OF THE INVENTION

In recent years, with increasing concerns about health issues, indoor air quality has drawn more and more attention, therefore, it is desirable to develop the coating composition with good formaldehyde abatement. Besides good formaldehyde abatement, for some coatings, especially the interior coating for kid's room, it is also desirable to have good stain resistance and scrub resistance. Many technical solutions have been proposed to develop interior coating that could have such properties.

CN113185635A discloses the polymer emulsion, based on the total amount of the polymer, comprises (a) 5%-35% by weight of (methyl) acrylic acid dodecyl to octadecyl alkyl ester; (b) 1%-14% by weight of an itaconate monomer; (c) 0.1%-10% by weight of an unsaturated hydrophilic monomer; (d) 41%-93.9% by weight of other ethylenically unsaturated monomers different from (a), (b) and (c). However, a special monomer is applied to obtain such coating composition.

Therefore, there is still a need to develop a coating which having good formaldehyde abatement, stain resistance and scrub resistance.

### SUMMARY OF THE INVENTION

It was surprisingly found that a coating composition comprises binder containing polymer and/or copolymer of at least one acetoacetyl functional ethylenically unsaturated monomer, at least one of polyalkylenimines and/or polyetheramine polyol, and optionally at least one polyether amine, having good formaldehyde abatement, stain resistance and scrub resistance.

One objective of the present disclosure is to provide a coating composition comprises binder containing polymer and/or copolymer of at least one acetoacetyl functional ethylenically unsaturated monomer, at least one of polyalkylenimines and/or polyetheramine polyol, and optionally at least one polyether amine.

Another objective of the present disclosure is to provide the process to prepare the above coating composition according to the present disclosure.

### DETAILED DESCRIPTION OF THE INVENTION

Unless otherwise specified, all terms/terminology/nomenclatures used herein have the same meaning as commonly understood by the skilled person in the art to which this invention belongs to.

Expressions “a”, “an” and “the”, when used to define a term, include both the plural and singular forms of the term.

The term “polymer” or “polymers”, as used herein, includes both homopolymer(s), that is, polymers prepared from a single reactive compound, and copolymer(s), that is, polymers prepared by reaction of at least two polymer forming reactive, monomeric compounds.

The designation (meth)acrylate and similar designations are used herein as an abbreviated notation for “acrylate and/or methacrylate”.

One objective of the present disclosure is to provide a coating composition comprises binder containing polymer and/or copolymer of at least one acetoacetyl functional ethylenically unsaturated monomer, at least one of polyalkylenimines and/or polyetheramine polyol, and optionally at least one polyether amine.

The acetoacetyl functional ethylenically unsaturated monomer according to the present invention has an acetoacetoxy or acetoacetamino functional group attached to an ethylenically unsaturated moiety. Preferably, the acetoacetyl functional ethylenically unsaturated monomer is of formula (I) or formula (II)

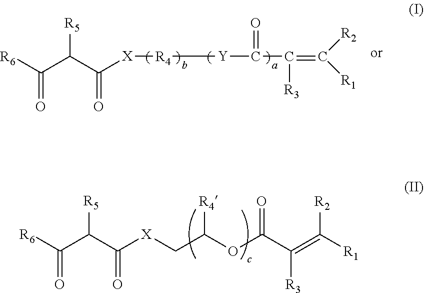

wherein
R₁ is H or C₁₋₁₀-alkyl;
R₂ is H, C₁₋₁₀-alkyl or phenyl which is optionally substituted with at least one of C₁₋₁₀-alkyl, F, Cl, Br, I, CN, hydroxyl and C₁₋₁₀-alkoxy groups;
R₃ is H, C₁₋₁₀-alkyl or phenyl which is optionally substituted with at least one of C₁₋₁₀-alkyl, F, Cl, Br, I, CN, hydroxyl and C₁₋₁₀-alkoxy groups;
R₄ is C₁₋₁₀-alkylene or phenylene;
R₅ is H, C₁₋₁₀-alkyl or phenyl which is optionally substituted with at least one of C₁₋₁₀-alkyl, F, Cl, Br, I, CN, hydroxyl and C₁₋₁₀-alkoxy groups;
R₆ is C₁₋₁₀-alkyl;
R₄′ is H or C₁₋₄-alkyl;
X and Y are each independently O or N;
a and b are each independently 0 or 1, which are not simultaneously zero; and
c is a number in the range of 2 to 10.

The term “C₁₋₁₀-alkyl” as used herein generally includes both linear and branched aliphatic hydrocarbon moieties having 1 to 10 carbons, preferably 1 to 6 carbons (C₁₋₆-alkyl), more preferably 1 to 4 carbons (C₁₋₄-alkyl), for example, methyl, ethyl, n-propyl, i-propyl, butyl, t-butyl, i-butyl, pentyl, n-hexyl and isomeric groups, n-heptyl and isomeric groups such as 4,4-dimethylpentyl, n-octyl and isomeric groups such as 2,2,4-trimethylpentyl, n-nonyl and isomeric groups, n-decyl and isomeric groups, or aliphatic cyclic hydrocarbon radicals containing 3 to 10 carbons, preferably 3 to 8 carbons, such as cyclopropyl, cyclobutyl, cyclopentyl, cyclohexyl, cycloheptyl and cyclooctyl.

The term “C₁₋₁₀-alkylene” as used herein generally includes both linear and branched bivalent aliphatic hydrocarbon radicals having 1 to 10 carbons, preferably 1 to 6 carbons (C₁₋₆-alkylene), more preferably 1 to 4 carbons (C₁₋₄-alkylene), for example, methylene, ethylene, propylene, butylene, pentylene, hexylene, heptylene, octylene, nonylene, decylene, 1-methyl ethylene, 1-ethyl ethylene, 1-ethyl-2-methyl ethylene, 1,1-dimethyl ethylene and 1-ethyl propylene.

The term “C₁₋₁₀-alkoxy” as used herein generally includes both linear and branched alkoxy having 1 to 10 carbons, preferably 1 to 6 carbons (C₁₋₆-alkoxy), more preferably1 to 4 carbons (C₁₋₄-alkoxy), for example, methoxy, ethoxy, n-propoxy, isopropoxy, n-butoxy, sec-butoxy, tert-butoxy, n-amyloxy, isoamyloxy, tert-amyloxy, heptyloxy, octyloxy, isooctyloxy, nonyloxy and decyloxy.

In a particular embodiment of the acetoacetyl functional ethylenically unsaturated monomer of formula (I), a is 0 or 1, and b is 1.

In a preferable embodiment of the acetoacetyl functional ethylenically unsaturated monomer of formula (I), R₁, R₂ and R₃ are, independently from each other, selected from H and C₁₋₄-alkyl, preferably methyl or ethyl; R₄ is C₁₋₄-alkylene, preferably methylene or ethylene; R₅ is selected from H and methyl, preferably H; R₆ is selected from methyl, ethyl and propyl, preferably methyl; X is O or N, preferably O; Y is O; a is 0 or 1, bis 1.

In a further preferable embodiment of the acetoacetyl functional ethylenically unsaturated monomer of formula (I), R₁, R₂ and R₃ are, independently from each other, selected from H and methyl; R₄ is methylene or ethylene; R₅ is H; R₆ is methyl; X is O or N, preferably O; a is 0; and b is 1.

In a preferable embodiment of the acetoacetyl functional ethylenically unsaturated monomer of formula (I), R₁, R₂ and R₃ are, independently from each other, selected from H and methyl; R₄ is methylene or ethylene; R₅ is H; R₆ is methyl; X is O or N, preferably O; Y is O; both a and b are 1.

In a preferable embodiment of the acetoacetyl functional ethylenically unsaturated monomer of formula (II), R₁, R₂ and R₃ are, independently from each other, selected from H and C₁₋₄-alkyl, preferably methyl or ethyl; R₅ is selected from H and methyl, preferably H; R₆ is selected from methyl, ethyl and propyl, preferably methyl; X is O or N, preferably O; R₄′ is selected from H, methyl and ethyl; and c is 2, 3, 4, 5, 6, 7 or 8.

In a further preferable embodiment of the acetoacetyl functional ethylenically unsaturated monomer of formula (II), R₁, R₂ and R₃ are, independently from each other, selected from H and methyl; R₅ is H; Re is methyl; R₄′ is H or methyl; X is O or N, preferably O; and c is 2, 3, 4, 5, 6, 7 or 8.

In one further preferable embodiment, the acetoacetyl functional ethylenically unsaturated monomer of formula (I) can be selected from compounds listed in Table 1 (with X═O, Y═O, R₅=H and R₆=CH₃):

TABLE 1

| | a= | b= | R₁= | R₂= | R₃= | R₄= |
|---|---|---|---|---|---|---|
| Structure IA1 | 0 | 1 | H | H | H | CH₂ |
| Structure IA2 | 0 | 1 | H | H | H | C₂H₄ |
| Structure IA3 | 0 | 1 | H | H | H | C₄H₈ |
| Structure IA4 | 0 | 1 | H | H | CH₃ | CH₂ |
| Structure IA5 | 0 | 1 | H | H | CH₃ | C₂H₄ |
| Structure IA6 | 0 | 1 | H | H | CH₃ | C₄H₈ |
| Structure IA7 | 0 | 1 | CH₃ | H | H | CH₂ |
| Structure IA8 | 0 | 1 | CH₃ | H | H | C₂H₄ |
| Structure IA9 | 0 | 1 | CH₃ | H | H | C₄H₈ |
| Structure IA10 | 0 | 1 | CH₃ | H | CH₃ | CH₂ |
| Structure IA11 | 0 | 1 | CH₃ | H | CH₃ | C₂H₄ |
| Structure IA12 | 0 | 1 | CH₃ | H | CH₃ | C₄H₈ |
| Structure IA13 | 0 | 1 | CH₃ | CH₃ | H | CH₂ |
| Structure IA14 | 0 | 1 | CH₃ | CH₃ | H | C₂H₄ |
| Structure IA15 | 0 | 1 | CH₃ | CH₃ | H | C₄H₈ |
| Structure IA16 | 0 | 1 | CH₃ | CH₃ | CH₃ | CH₂ |
| Structure IA17 | 0 | 1 | CH₃ | CH₃ | CH₃ | C₂H₄ |
| Structure IA18 | 0 | 1 | CH₃ | CH₃ | CH₃ | C₄H₈ |
| Structure IA19 | 1 | 1 | H | H | H | CH₂ |
| Structure IA20 | 1 | 1 | H | H | H | C₂H₄ |
| Structure IA21 | 1 | 1 | H | H | H | C₄H₈ |
| Structure IA22 | 1 | 1 | H | H | CH₃ | CH₂ |
| Structure IA23 | 1 | 1 | H | H | CH₃ | C₂H₄ |
| Structure IA24 | 1 | 1 | H | H | CH₃ | C₄H₈ |
| Structure IA25 | 1 | 1 | CH₃ | H | H | CH₂ |
| Structure IA26 | 1 | 1 | CH₃ | H | H | C₂H₄ |
| Structure IA27 | 1 | 1 | CH₃ | H | H | C₄H₈ |
| Structure IA28 | 1 | 1 | CH₃ | H | CH₃ | CH₂ |
| Structure IA29 | 1 | 1 | CH₃ | H | CH₃ | C₂H₄ |
| Structure IA30 | 1 | 1 | CH₃ | H | CH₃ | C₄H₈ |
| Structure IA31 | 1 | 1 | CH₃ | CH₃ | H | CH₂ |
| Structure IA32 | 1 | 1 | CH₃ | CH₃ | H | C₂H₄ |
| Structure IA33 | 1 | 1 | CH₃ | CH₃ | H | C₄H₈ |
| Structure IA34 | 1 | 1 | CH₃ | CH₃ | CH₃ | CH₂ |
| Structure IA35 | 1 | 1 | CH₃ | CH₃ | CH₃ | C₂H₄ |
| Structure IA36 | 1 | 1 | CH₃ | CH₃ | CH₃ | C₄H₈ |

In another further preferable embodiment, the acetoacetyl functional ethylenically unsaturated monomer of formula (I) can be selected from compounds listed in Table 2 (with X=O, Y=N, R₅=H and R₆=CH₃):

TABLE 2

| | a= | b= | R₁= | R₂= | R₃= | R₄= |
|---|---|---|---|---|---|---|
| Structure IB1 | 1 | 1 | H | H | H | CH₂ |
| Structure IB2 | 1 | 1 | H | H | H | C₂H₄ |
| Structure IB3 | 1 | 1 | H | H | H | C₄H₈ |
| Structure IB4 | 1 | 1 | H | H | CH₃ | CH₂ |
| Structure IB5 | 1 | 1 | H | H | CH₃ | C₂H₄ |
| Structure IB6 | 1 | 1 | H | H | CH₃ | C₄H₈ |
| Structure IB7 | 1 | 1 | CH₃ | H | H | CH₂ |
| Structure IB8 | 1 | 1 | CH₃ | H | H | C₂H₄ |
| Structure IB9 | 1 | 1 | CH₃ | H | H | C₄H₈ |
| Structure IB10 | 1 | 1 | CH₃ | H | CH₃ | CH₂ |
| Structure IB11 | 1 | 1 | CH₃ | H | CH₃ | C₂H₄ |
| Structure IB12 | 1 | 1 | CH₃ | H | CH₃ | C₄H₈ |
| Structure IB13 | 1 | 1 | CH₃ | CH₃ | H | CH₂ |
| Structure IB14 | 1 | 1 | CH₃ | CH₃ | H | C₂H₄ |
| Structure IB15 | 1 | 1 | CH₃ | CH₃ | H | C₄H₈ |
| Structure IB16 | 1 | 1 | CH₃ | CH₃ | CH₃ | CH₂ |
| Structure IB17 | 1 | 1 | CH₃ | CH₃ | CH₃ | C₂H₄ |
| Structure IB18 | 1 | 1 | CH₃ | CH₃ | CH₃ | C₄H₈ |

In a third further preferable embodiment, the acetoacetyl functional ethylenically unsaturated monomer of formula (II) can be selected from compounds listed in Table 3 (with R₄′=H, R₅=H and R₆=CH₃):

TABLE 3

| | X= | c= | R₁= | R₂= | R₃= |
|---|---|---|---|---|---|
| Structure IIA1 | O | 2 | H | H | H |
| Structure IIA2 | O | 2 | H | H | CH₃ |
| Structure IIA3 | O | 2 | CH₃ | H | H |
| Structure IIA4 | O | 2 | CH₃ | H | CH₃ |
| Structure IIA5 | O | 2 | CH₃ | CH₃ | H |
| Structure IIA6 | O | 2 | CH₃ | CH₃ | CH₃ |
| Structure IIA7 | N | 2 | H | H | H |
| Structure IIA8 | N | 2 | H | H | CH₃ |
| Structure IIA9 | N | 2 | CH₃ | H | H |
| Structure IIA10 | N | 2 | CH₃ | H | CH₃ |
| Structure IIA11 | N | 2 | CH₃ | CH₃ | H |
| Structure IIA12 | N | 2 | CH₃ | CH₃ | CH₃ |
| Structure IIA13 | O | 3 | H | H | H |
| Structure IIA14 | O | 3 | H | H | CH₃ |
| Structure IIA15 | O | 3 | CH₃ | H | H |
| Structure IIA16 | O | 3 | CH₃ | H | CH₃ |
| Structure IIA17 | O | 3 | CH₃ | CH₃ | H |
| Structure IIA18 | O | 3 | CH₃ | CH₃ | CH₃ |
| Structure IIA19 | N | 3 | H | H | H |
| Structure IIA20 | N | 3 | H | H | CH₃ |
| Structure IIA21 | N | 3 | CH₃ | H | H |
| Structure IIA22 | N | 3 | CH₃ | H | CH₃ |
| Structure IIA23 | N | 3 | CH₃ | CH₃ | H |
| Structure IIA24 | N | 3 | CH₃ | CH₃ | CH₃ |

Examples of particular acetoacetyl functional ethylenically unsaturated monomers include, but are not limited to, compounds of following formulas

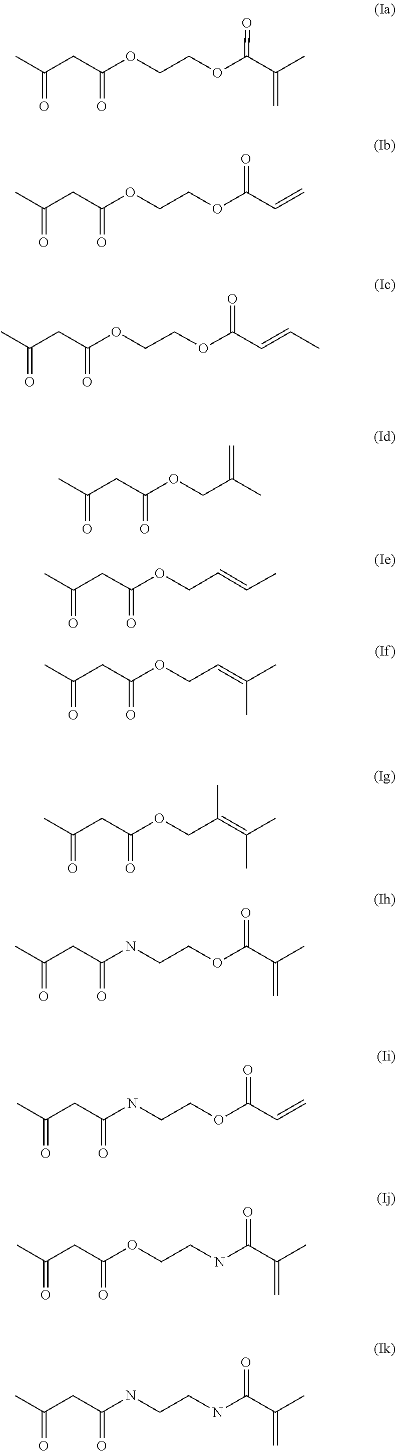

The copolymer of acetoacetyl functional ethylenically unsaturated monomer according to the present disclosure may contain at least one ethylenically unsaturated monomer other than the acetoacetyl functional ethylenically unsaturated monomer.

There is no particular restriction on the ethylenically unsaturated monomer that may be contained in the copolymer of acetoacetyl functional ethylenically unsaturated monomer according to the present disclosure. Examples of the optional ethylenically unsaturated monomer may include, but are not limited to, acrylic acid, methacrylic acid, acrylamide, methacrylamide, N,N-dimethylacrylamide (DMA), 2-hydroxyethylmethacrylate (HEMA), 2-hydroxyethyl acrylate, hydroxypropyl acrylate, hydroxypropyl methacrylate (HPMA), dimethylaminoethyl methacrylate (DMAEMA), dimethylaminoethylmethacrylamide, allyl alcohol, vinylpyridine, C₂₋₁₀-alkylene glycol diacrylate, C₂₋₁₀-alkylene glycol dimethacrylate, glycerol acrylate, glycerol methacrylate, ureido acrylate, ureido methacrylate, N-(1,1-dimethyl-3-oxobutyl) acrylamide, N-vinyl-2-pyrrolidone (NVP), N-vinyl formamide, N-vinyl acetamide, N-vinyl isopropylamide, N-vinyl-N-methyl acetamide, N-vinyl caprolactam, C₁₋₁₀-alkyl acrylates and C₁₋₁₀-alkyl methacrylates, C₁₋₁₀-alkyl acrylamides, C₁₋₁₀-alkyl methacrylamides, acrylonitrile, methacrylonitrile, vinyl C₁₋₁₀-alkanoates, C₂₋₁₀-alkenes, C₂₋₁₀-halo-alkenes, styrene, C₁₋₆-alkyl styrene, vinyl alkyl ethers in which the alkyl moiety has 1 to 6 carbon atoms. Preferably, the optional ethylenically unsaturated monomer is selected from acrylic acid, methacrylic acid, acrylamide, methacrylamide, methyl acrylate, ethyl acrylate, propylacrylate, isopropylacrylate, n-butyl acrylate, cyclohexylacrylate, 2-ethylhexylacrylate, methyl methacrylate, ethyl methacrylate, propyl methacrylate, n-butyl methacrylate, vinyl acetate, vinyl propionate, vinyl butyrate, vinyl valerate, styrene, chloroprene, vinyl chloride, vinylidene chloride, acrylonitrile, methacrylonitrile, 1-butene, butadiene, vinyl toluene and vinyl ethyl ether.

In one embodiment of the present disclosure, the polymer and/or copolymer of acetoacetyl functional ethylenically unsaturated monomer has a weight-average molecular weight (Mw) in the range of 5,000 to 3,000,000, preferably from 50,000 to 1,000,000, more preferably from 80,000 to 800,000, most preferably from 100,000 to 600,000 as measured by Gel Permeation Chromatography (GPC) against polystyrene standard in tetrahydrofuran.

There is no particular restriction on the process by which the polymer and copolymer of acetoacetyl functional ethylenically unsaturated monomer according to the present disclosure may be prepared. The polymer and copolymer of acetoacetyl functional ethylenically unsaturated monomer according to the present invention may be prepared by any suitable process known in the art for polymerization of ethylenically unsaturated monomer(s). For example, the polymer and copolymer of acetoacetyl functional ethylenically unsaturated monomer according to the present invention may be prepared by an emulsion or solution polymerization process, particularly a free-radical emulsion polymerization.

For the preparation of the polymer and copolymer of acetoacetyl functional ethylenically unsaturated monomer according to the present disclosure by, for example, free-radical emulsion polymerization, suitable free-radical polymerization initiators are all those capable of initiating free-radical emulsion polymerization. These may be, for example, peroxides, hydroperoxides, such as alkali metal peroxodisulfates; and azo compounds. Also suitable are initiator mixtures or redox initiator systems, for example, t-butyl hydroperoxide/sodium hydroxymethanesulfonate, hydrogen peroxide/ascorbic acid, sodium persulfate/sodium disulfite, tert-butyl hydroperoxide/sodium disulfite and ascorbic acid/iron (II) sulfate/sodium persulfate. The initiators may be used in any conventional amounts, for example, an amount of 0.01 to 5 wt. %, based on the amount of all monomer(s) to be polymerized.

For the free-radical emulsion polymerization, at least one emulsifier may be used in an amount of up to 30 wt. %, preferably 0.3 to 10 wt. % and more preferably 0.5 to 5 wt. %, based on the amount of all monomer(s) to be polymerized. Suitable emulsifiers include, but are not limited to, nonionic emulsifiers, such as ethoxylated mono-, di- and tri-alkylphenols (EO: 3 to 50, alkyl radical: C₄-C₉), ethoxylates of long-chain alcohols (EO: 3 to 50, alkyl radical: C₈-C₃₆) and polyethylene oxide/polypropylene oxide block copolymers; anionic emulsifiers, such as alkali metal salts and ammonium salts of alkyl sulfates (alkyl radical: C₈-C₁₂), alkali metal salts and ammonium salts of ethoxylated alkanol sulfate (EO: 2 to 50, alkyl radical: C₁₂-C₁₈), alkali metal salts and ammonium salts of ethoxylated alkylphenols (EO: 3 to 50, alkyl radical: C₄-C₉), alkali metal salts and ammonium salts of C₁₂-C₁₈ alkylsulfonic acids and of C₉-C₁₈ alkylarylsulfonic acids; cationic emulsifiers, and/or amphoteric emulsifiers. Further suitable emulsifiers can be found, for example, in HoubenWeyl, Methoden der organischen Chemie, Vol. 14/1, Makromolekulare Stoffe, Georg Thieme Verlag, Stuttgart, 1961, pages 192 to 208.

The free-radical emulsion polymerization for preparation of the polymer and copolymer of acetoacetyl functional ethylenically unsaturated monomer according to the present disclosure may be carried out in the absence or in the presence of a seed for adjustment of the polymer particle size. Any seed that is known suitable for free-radical emulsion polymerization, for example, a foreign polymer seed such as polystyrene seed or a polymer seed generated in situ, may be used. The processes for polymerization in the presence of a seed are, for example, described in Encyclopedia of Polymer Science and Technology, Vol. 5, John Wiley & Sons Inc., New York, 1966, page 847.

Other conventional substances useful for free-radical emulsion polymerization, for example, protective colloids, buffering agents, non-surfactant stabilizers and/or inert salts, may also be used for the preparation of the polymer and co-polymer of acetoacetyl functional ethylenically unsaturated monomer according to the present disclosure.

The free-radical emulsion polymerization for preparation of the polymer and co-polymer of acetoacetyl functional ethylenically unsaturated monomer according to the present disclosure is not subjected to any real limitations with regard to the process parameters. For example, the free-radical emulsion polymerization may be carried out at a temperature between 2° and 100° C., preferably between 5° and 95° C., in particular between 6° and 90° C., and at atmospheric pressure or under a light vacuum.

In one embodiment, the polyalkylenimines according to the present disclosure include but not limited to polyethylenimine and polypropylenimine, etc.

The term polyethylenimine does not only refer to polyethylenimine homopolymers but also to polyalkylenimines containing NH—CH₂—CH₂—NH units together with other alkylene diamine units, for example, NH—CH₂—CH₂—CH₂—NH units, NH—CH₂—CH(CH₃)—NH units, NH—(CH₂)₄—NH units, NH(CH₂)₆—NH units or NH—(CH₂)₈—NH units, but NH—CH₂—CH₂—NH units being in the majority with respect to the molar share, for example amounting to 60 mol % or more, more preferably amounting to at least 70 mol %, referring to all alkylenimine units. In a particular embodiment, the term polyethylenimine refers to those polyalkylenimines that contain only one or zero alkylenimine unit other than NH—CH₂—CH₂—NH per polyethylenimine structural unit.

The polyethylenimines are commercially available or may be obtained by a skilled person in the art via well-known processes. Suitable processes for preparing polyethylenimines are well known. For example, linear polyethylenimines may be prepared for example by post-modification of other polymers such as poly(2-oxazolines), as described in High Molecular Weight Linear Polyethylenimine and Poly (N-methylethylenimine), Tanaka, Ryuichi, et al, Macromolecules. 16 (6), 849-853, 1983, or N-substituted polyaziridines, as described in New Synthesis of Linear Polyethylenimine, Weyts, Katrien F. and Goethals, Eric J., Polymer Bulletin, 19 (1), 13-19, 1988; branched polyethylenimines may be prepared for example by the ring opening polymerization of aziridine, which has been developed for a long time, for example, as described in Advances in the Chemistry of Polyethyleneimine (Polyaziridine), Zhuk, D. S., Gembitskii, P. A., and Kargin V. A., Russian Chemical Reviews, Vol 34 (7), 515-526, 1965.

The term polypropylenimine in the context of the present invention does not only refer to polypropylenimine homopolymers but also to polyalkylenimines containing NH—CH₂—CH(CH₃)—NH units together with other alkylene diamine units, for example, NH—CH₂—CH₂—CH₂—NH units, NH—CH₂—CH₂—NH units, NH—(CH₂)₄—NH units, NH—(CH₂)₆—NH units or NH—(CH₂)₈—NH units but NH—CH₂—CH(CH₃)—NH units being in the majority with respect to the molar share. Preferred polypropylenimines contain NH—CH₂—CH(CH₃)—NH units being in the majority with respect to the molar share, for example amounting to 60 mol % or more, more preferably amounting to at least 70 mol %, referring to all alkylenimine units. In a special embodiment, the term polypropylenimine refers to those polyalkylenimines that bear only one or zero alkylenimine unit other than NH—CH₂—CH(CH₃)NH per polypropylenimine structural unit.

In one embodiment, the polyalkylenimines according to the present disclosure generally have a weight average molecular weight (M_{w}) in the range of about 100 to about 4×10⁶, preferably in the range of about 200 to about 2×10⁵, or in the range of about 200 to about 2×10⁴, most preferably in the range of about 300 to about 2×10⁴, or in the range about 500 to 2×10³ g/mol.

The term “polyetheramine polyol” means a polymer having amine groups, ether groups and hydroxyl groups.

In one embodiment, the polyetheramine polyol according to the present disclosure is the branched polyetheramine polyol.

In one preferred embodiment, the water solubility of the branched polyetheramine polyol is preferably at least 5 g/l, more preferably at least 10 g/l, in particular at least 50 g/l, especially 100 g/l, at 20° C. More preferably, the branched polyetheramine polyol is completely water miscible at 20° C.

In another preferred embodiment, essentially all of the amino groups in the branched polyetheramine polyol are tertiary amine groups. The term “essentially” means that at least 90%, preferably at least 95%, more preferably more than 98%, and even more preferably more than 99% of the amino groups in the branched polyetheramine polyol are tertiary amine groups. Frequently, the branched polyetheramine polyol contains on average less than 0.5 mol/kg of secondary and primary amino groups, if any. In particular, the polyetheramine polyol contains on average less than 0.2 mol/kg, especially less than 0.1 mol/kg of secondary and primary amino groups, if any.

In another embodiment, the branched polyetheramine polyol contains 4 to 8.2 mol/kg, preferably 5 to 8.0 mol/kg, more preferably 5 to 7.9 mol/kg, of tertiary amino groups,

In another embodiment, the amine number of polyetheramine polyol according to the present disclosure is 100 to 700 mg KOH/g, preferably 200 to 500 mg KOH/g, determined according to the method described in DIN EN ISO 9702:1998. Besides determination of the total amine group content, this method allows for determination of the tertiary amine group content, the secondary amine group content, and the primary amine group content.

In addition to the amino groups, the polyetheramine polyol according to the present disclosure contains hydroxyl groups. In one embodiment, the OH number of the polyetheramine polyol is at least 100 mg KOH/g, e.g., 100 to 800 mg KOH/g, preferably at least 200 mg KOH/g, e.g. 200 to 700 mg KOH/g, more preferably at least 250 mg KOH/g, e.g. 250 to 650 mg KOH/g, determined according to DIN 53240, part 2.

The number of hydroxyl groups per molecule of the polyetheramine polyol according to the present disclosure depend on the number average molecular weight, Mn, of the branched polyetheramine polyol and the degree of branching. In one embodiment, the branched polyetheramine polyol contains on average (number average) at least four, more preferably at least six, more preferably at least ten, hydroxyl groups per molecule. In principle, there is no upper limit on the number of terminal or pendent functional groups. Preferably, the branched polyetheramine polyol contains on average (number average) at most 500, in particular at most 200 terminal hydroxyl groups per molecule.

The weight-average molar weight, Mw, of polyetheramine polyol is 1000 to 200000 g/mol, preferably 2000 to 150000 g/mol, more preferably 3000 to 100000 g/mol, most preferably 4000 to 50000 g/mol determined by gel permeation chromatography using hexafluoroisopropanol as the mobile phase and polymethylmethacrylate as a standard. In another embodiment, Mn of branched polyetheramine polyol is 500 to 55000 g/mol, preferably 1000 to 40000 g/mol, determined by gel permeation chromatography using hexafluoroisopropanol as the mobile phase and polymethylmethacrylate as a standard. The polydispersity, i.e. the ratio Mw/Mn, of the polyetheramine polyol is frequently in the range of from 1.1 to 25, in particular in the range of 1.5 to 20.

The dynamic viscosity of the branched polyetheramine polyol is frequently in the range of from 5 to 200 Pa^{-s}, determined at 23° C. according to ASTM D7042, in particular in the range from 8 to 150 Pa^{-s}.

The term “branched” describes that the polyetheramine polyol does not have linear structure, but has a significant amount of branching points within the polymer backbone, which result in a branched polymer chain. Such branching points may be tri or tetra-substituted carbon atoms and/or tertiary amino groups. The branching points are in particular the tertiary amino groups.

The Hazen color number of the polyetheramine polyol is preferably in the range of from 100 to 600 (APHA), determined according to DIN ISO 6271.

The polyetheramine polyol is frequently amorphous and thus may show a glass transition. In one embodiment of the present disclosure, the glass transition temperature of the polyetheramine polyol does not exceed 50° C., preferably in the range of −55 to 30° C. and more preferably in the range of −55 to 10° C., determined by differential scanning calorimetry. Branched polyetheramine polyols and their preparation are known, for example from DE 3206459, EP 441 198, WO 2009/047269, WO 2014/012812, which discloses branched polyetheramine polyols based on a polycondensation product of at least one trialkanolamine.

In one embodiment of the present disclosure, the branched polyetheramine polyol is obtainable by polycondensation of at least one trialkanolamine or by polycondensation of a mixture of at least one trialkanolamine with an aliphatic or cycloaliphatic polyol. Said trialkanolamines are preferably selected from tri-C2-C8-alkanol amines, wherein the alkanol groups in trialkanolamine may be different or identical, preferably the alkanol groups are identical. More preferably, the trialkanolamines are selected from tri-C2-C4-alkanol amines, wherein the alkanol groups are identical. Particularly preferred trialkanolamines are triethanolamine, tri-n-propanolamine, triisopropanolamine, tri-n-butanolamine, and triisobutanolamine and mixtures thereof. Suitable aliphatic or cycloaliphatic polyols are for example aliphatic diols, aliphatic polyols bearing more than 2 hydroxyl groups, cycloaliphatic diols, and cycloaliphatic polyols having more than 2 hydroxyl groups. Preferred are aliphatic diols and aliphatic polyols bearing more than 2 hydroxyl groups. Examples of aliphatic diols are C2-C20-diols, such as ethandiol, propandiol, butandiol, pentandiol, hexandiol, heptandiol, octandiol, and their structural isomers. Further examples of aliphatic diols are polyether diols of the general formula HO—((CH₂)ₙ—O)ₘ—H with n being independently from each other 1 to 10, preferably 2 to 4 and m being in the range of 2 to 100. Preferably, the polyether diols are selected from polyethylene glycol, polypropylene glycol, polytetramethylene glycol, and copolymers thereof. Examples of polyols having more than 2 hydroxyl groups are glycerol, pentaerythritol, trimethylolpropane, sorbitol, and the like. The polyols may also be alkoxylated, in particular ethoxylated or propoxylated, e.g. ethoxylated glycerol, propoxylated glycerol, ethylated pentaerythritol, propoxylated pentaerythritol, ethoxylated trimethylolpropane, propoxylated trimethylolpropane, ethoxylated sorbitol and propoxylated sorbitol. Usually the degree of alkoxylation, i.e. the number average of alkyleneoxide moieties, will not exceed 100 and is frequently in the range from 2 to 50.

Preferably, the polyetheramine polyol is obtainable by polycondensation, wherein monomers contain to at least 50% by weight, preferably at least 70% by weight, more preferably at least 80% by weight, based on the total amount of monomers, of compounds selected from trialkanolamines. The polyetheramine polyol is preferably obtainable by polycondensation of monomers containing 50 to 100 mol % of compounds selected from trialkanolamines and 0 to 50 mol % of compounds selected from aliphatic or cycloaliphatic polyols, preferably containing 70 to 100 mol % of compounds selected from trialkanolamines and 0 to 30 mol % of compounds selected from aliphatic or cycloaliphatic polyols, more preferably containing 80 to 100 mol % of compounds selected from trialkanolamines and 0 to 20 mol % of compounds selected from aliphatic or cycloaliphatic polyols, whereby “mol %” are based on the total amount of monomers.

In a particular embodiment, the polyetheramine polyol is obtainable by polycondensation, wherein monomers consist only of monomers selected from trialkanolamines. The trialkanolamine is preferably selected from tri-C2-C4-alkanolamines. Preferred tri-C2-C4-alkanolamines are selected from triethanolamine, triisopropanolamine, and tri-n-propanolamine.

The mixture of at least one trialkanolamine with an aliphatic or cycloaliphatic polyol is preferably selected form mixtures of at least one trialkanolamine, which is selected from the group consisting of tri-C2-C4-alkanolamines, and an aliphatic or cycloaliphatic C2-C8-polyol.

Particular preference is given to polyetheramine polyols obtainable by polycondensation of either triethanolamine, or of triisopropanolamine, or of a mixture of triethanolamine and triisopropanolamine. In this embodiment, optionally at least one further polyol, in particular at least one further diol might be present.

The polycondensation can be carried out with or without the presence of a catalyst. Suitable catalysts include but are not limited to phosphoric acid (H₃PO₄), phosphorous acid (H₃PO₃) or hypophosphoric acid (H₃PO₂), which can be applied in bulk or as aqueous solution. Preferably, the catalyst is added in an amount of from 0.001 to 10 mol %, preferably from 0.005 to 7 mol %, more preferably from 0.01 to 5 mol %, based on the amount of the trialkanolamine.

The polycondensation can be carried out by using a solvent. Examples of solvents that can be used to perform the inventive process are aromatic and/or (cyclo) aliphatic hydrocarbons and their mixtures, halogenated hydrocarbons, ketones, esters, and ethers. Preference is given to aromatic hydrocarbons, (cyclo) aliphatic hydrocarbons, alkyl esters of alkanoic acids, ketones, alkoxylated alkyl esters of alkanoic acids, and mixtures thereof. Particularly preferred are monoalkylated or polyalkylated benzenes and naphthalenes, ketones, alkyl esters of alkanoic acids, and alkoxylated alkyl esters of alkanoic acids and mixtures thereof. The polycondensation is preferably carried out without using a solvent.

The polycondensation can be carried out in a way that the temperature during polycondensation does not exceed 250° C. and preferably not exceed 230° C. For example, the polycondensation is carried out at temperatures in the range of from 150 to 230° C., preferably 180 to 215°, more preferably 180 to 215° C.

The polycondensation can be carried out at a pressure in the range of from 0.02 to 20 bar. Preferably, the polycondensation is carried out at Normal Pressure. The polycondensation is preferably followed by removal or blow-off of residual monomers, for example by distilling them off at Normal Pressure or at reduced pressure, for example, in the range of from 0.1 to 0.5 bar.

Water or other volatile products that are released during the polycondensation can be removed from the reaction mixture in order to accelerate the reaction. Preferably, water or other volatile products that are released during the polycondensation are removed, such removal being accomplished by distillation, for example, and optionally under reduced pressure. The removal of water or of other low molecular mass reaction by-products can also be assisted by passing through the reaction mixture a stream of gas which is substantially inert under the reaction conditions (stripping), such as nitrogen, for example, or a noble gas such as helium, neon, or argon, for example.

The branched polyetheramine polyols described herein are typically stable at room temperature for a prolonged period, such as for at least 10 weeks, for example. In particular, the polyetheramine polyols are stable without exhibiting instances of clouding, precipitation, and/or significant increase in viscosity.

The polycondensation can be terminated by a variety of options. For example, the temperature can be lowered to a range in which the reaction comes to a standstill and the polycondensation product is storage-stable. This is generally the case below 100° C., preferably below 60° C., more preferably below 40° C., and very preferably at room temperature. Another option is to deactivate the catalyst by adding a basic component, a Lewis base or an organic or inorganic base, for example.

The polycondensation can be carried out in stirred tank reactors or stirred tank reactor cascades. The process can be carried out batch-wise, in semi-batch mode or continuously. Polycondensation products of trialkanolamines and poly-co-condensation products of trialkanolamines as described herein are preferably used as polyetheramine polyol without chemical modification or derivatization. However, a derivative of a polycondensation product of trialkanolamines or a derivative of a poly-co-condensation product of a trialkanolamine can be used instead of a non-derivatized polycondensation product.

Derivatives of such polycondensation and poly-co-condensation products of trialkanolamines include products obtained by alkoxylation of the hydroxyl end groups of the non-derivatized polycondensation and poly-co-condensation products. Likewise, it is possible to modify the nonderivatized polycondensation or poly-co-condensation products by hydrophobic groups or hydrophilic groups. Hydrophobization or hydrophilization can be achieved by reacting a part of the hydroxylic end groups with selected reactants. The amino groups of the polycondensation and poly-co-condensation products can also be quaternized to obtain permanently cationic modified polymers by use of alkylating agents. Derivatives of such polycondensation and polyco-condensation products of trialkanolamines are described for example in US 2011/0168045, WO 2009/060060 and WO 2009/112379 to which reference is made. In one preferred embodiment, the derivatized products are alkoxylated polycondensation and poly-cocondensation products.

The polyetheramine polyol usually dissolves readily in a variety of solvents, such as water, alcohols, such as methanol, ethanol, n-butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate, or propylene carbonate.

In one embodiment, the polyether amines according to the present disclosure have a weight average molecular weight in the range of 104 to 8,000, preferably 148 to 6,000 and more preferably 200 to 4,000. Any polyether amines commercially available or obtainable by a known process may be used, such as, polyether diamines, polyether triamines, or any combination thereof.

In another embodiment, the polyether amines according to the present disclosure may be selected from polyether diamines having a structure of formula (III)

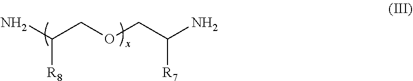

wherein
R₇ is H or methyl, preferably methyl;
R₈ is H or methyl, preferably methyl; and
x is a number such that the polyether diamines have a weight-average molecular weight (Mw) in the range of 104 to 8,000, preferably 148 to 6,000 and more preferably 200 to 4,000.

In another embodiment, the polyether amines according to the present disclosure may also be selected from polyether triamines having a structure of formula (IV),

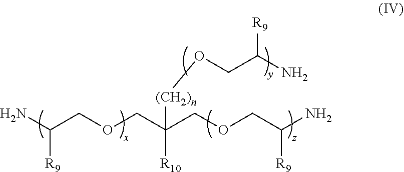

wherein
R₉ is H, methyl or ethyl, preferably methyl;
R₁₀ is H or C1-10-alkyl, preferably H or C1-4-alkyl, more preferably H, methyl, ethyl, propyl or butyl; and
x, y, z are independent numbers such that the polyether triamines have a weight-average molecular weight (Mw) in the range of 300 to 6,000, preferably 400 to 5,000, for example, 440 to 3,000.

In a particular embodiment, a polyether diamine having a structure of the following formula (V)

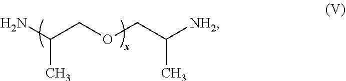

wherein x is a number such that the polyether diamine has a weight-average molecular weight (Mw) in the range of 132 to 8,000, preferably 190 to 6,000 and more preferably 230 to 4,000.

In one embodiment, the at least one acetoacetyl functional ethylenically unsaturated monomer according to the present disclosure used to prepare the polymer and/or copolymer thereof is in the amount of 0.1 to 10 wt. %, preferably 0.1 to 5 wt. %, more preferably 0.1 to 3 wt. %, most preferably 0.3 to 2 wt. %, based on the total weight of the coating composition.

In another embodiment, the at least one of polyalkylenimines and/or polyetheramine polyol is present in the coating composition in the amount of 0.1 to 10 wt. %, preferably 0.1 to 3 wt. %, more preferably 0.1 to 2 wt. %, most preferably 0.1 to 1 wt. %, based on the total weight of the coating composition.

In another embodiment, the at least one polyether amine is present in the coating composition in the amount of 0 to 10 wt. %, preferably 0.1 to 5 wt. %, preferably 0.2 to 3 wt. %, more preferably 0.3 to 2 wt. %, most preferably 0.3 to 1 wt. %, based on the total weight of the coating composition.

The type of the coating composition is not limited, which may be, for example, interior coatings like wall paints, radiator coatings and floor coatings, and also coatings for windows and doors. The coating composition may have a solid content of 20 to 80 wt. %, preferably 50 to 75 wt. %, based on the total weight of the composition. The coating composition may even have a lower solid content if no pigment and/or filler were comprised. For example, a coating composition comprising neither pigment nor filler may have a solid content as low as 5 wt. %, based on the total weight of the composition.

The term “binder” as used herein refers to organic, polymeric compounds which are responsible for forming film among other components of the coating composition. The coating composition may comprise at least one binder. The binder may be present in an amount of 1 to 90 wt. %, preferably 5 to 80 wt. %, preferably of 10 to 70 wt. %, more preferably of 15 to 60 wt. %, more preferably of 20 to 50 wt. % and most preferably 25 to 40 wt. %, based on the total weight of the coating composition.

There is no particular restriction on the binder that may be present in the coating composition according to the present disclosure. Binders which are useful for the coating composition include, but are not limited to, alkyd resins, epoxy resins, polyurethanes, vinyl acetate/ethylene copolymers, water glasses, more particularly potassium waterglasses, and also binders based on acrylates, styrene and/or vinyl esters such as styrene acrylates or butyl acrylates.

For example, it is preferable for wall paints to comprise vinyl acetate/ethylene copolymers, styrene acrylates, butyl acrylates or mixtures of these polymers as the binder; and it is preferable for radiator and floor coatings, and coatings for windows and doors to comprise polyurethanes, acrylates, alkyd resins, epoxy resins and any mixture thereof.

There is no particular restriction on the incorporation manner of the polymer and/or copolymer of acetoacetyl functional ethylenically unsaturated monomer into the binder. In one embodiment, the polymer and/or copolymer of acetoacetyl functional ethylenically unsaturated monomer, bulk or a water emulsion thereof, may be first incorporated in a small fraction of binder to obtain a dispersion containing the polymer and/or copolymer of acetoacetyl functional ethylenically unsaturated monomer, which is then incorporated into the remaining binder to formulate a coating composition. In another preferred embodiment, the acetoacetyl functional ethylenically unsaturated monomer could be added before and/or during the process of polymerization of alkyd resins, epoxy resins, polyurethanes, vinyl acetate/ethylene copolymers, water glasses, etc. to prepare the co-polymers contained binder. In a more preferred embodiment, the acetoacetyl functional ethylenically unsaturated monomer is added together with other monomer of alkyd resins, epoxy resins, polyurethanes, vinyl acetate/ethylene copolymers, water glasses, etc. to prepare the copolymers contained in the binder.

Additionally, the coating composition may contain further components, such as pigment, filler, solvent, water, and further additives such as preservative, thickener, dispersant and defoamer.

Suitable pigment includes, for example, inorganic white pigments, such as titanium dioxide, barium sulfate, zinc oxide, zinc sulfide, basic lead carbonate, antimony trioxide, and lithopones; inorganic colored pigments, such as iron oxides, carbon black, graphite, zinc yellow, zinc green, Ultramarin, manganese black, antimony black, and manganese violet; organic color pigments, such as indigo, azo dyes, anthraquinoids and indidental dyes, as well as dioxazine, quinacridone, phthalocyanine, isoindolinone and metal complex pigments. Also suitable are synthetic white pigments with air inclusions for increasing light scattering, such as the Rhopaque® dispersions. The pigment may be present, if present, in an amount of 20 to 80 wt. %, preferably 50 to 75 wt. % in the case of wall paints, or in an amount of no more than 25 wt. %, preferably no more than 15 wt. %, most preferably no more than 10 wt. % in the case of transparent or semi-transparent coatings, based on the total weight of the coating composition.

Suitable filler includes, for example, kaolin, talc, mica, magnesite, alkaline earth carbonates such as calcite or chalk, magnesium carbonate, dolomite, alkaline earth sulfates such as calcium sulfate, silicon compounds such as silicon dioxide or aluminum silicates or magnesium aluminum silicates, and aluminum oxide or aluminum oxide hydrate. The filler may be present, if present, in an amount of 1 to 90 wt. %, preferably 20 to 60 wt. % in the case of wall paint, or in an amount of no more than 5 wt. %, preferably no more than 2 wt. %, most preferably no more than 1 wt. % in the case of transparent or semi-transparent coatings, based on the total weight of the coating composition.

Suitable organic solvent includes, for example, trimethylpentane, propylene glycol or dipropylene glycol butyl ether. The organic solvent may be present, if present, in an amount of less than 5 wt. %, based on the total weight of the coating composition.

Suitable preservative includes, for example, isothiazolinone preparations such as 2-methyl-2Hisothiazol-3-one or 1,2-benzisothiazolin-3H-one. The preservative may be present in an amount of less than 2 wt. %, preferably less than 0.3 wt. %, based on the total weight of the coating composition.

Suitable thickener includes, for example, cellulose ethers, bentonite, polysaccharides, fumed silica, phyllosilicates, or polyurethane thickeners. The thickener may be present in an amount of less than 1 wt. %, preferably less than 0.6 wt. %, based on the total weight of the coating composition.

Suitable dispersant includes, for example, alkylbenzenesulfonates, polycarboxylates, fatty acid amines or salts of polyacrylic acids. The dispersant may be present in an amount of less than 2 wt. %, preferably 0.001 to 0.5 wt. %, based on the total weight of the coating composition.

Suitable defoamer includes, for example, poly(organo) siloxanes, silicone oils or mineral oils. The defoamer may be present in an amount of less than 1 wt. %, more preferably 0 to 0.5 wt. %, based on the total weight of the coating composition.

Another objective of the present disclosure is to provide the process to prepare the above coating composition according to the present disclosure, which comprising mixing binder contains polymer and/or copolymer of acetoacetyl functional ethylenically unsaturated monomer, at least one of polyalkylenimines and/or polyetheramine polyol and optionally polyether amine as well as other additives under room temperature.

The present invention is further demonstrated and exemplified in the following Examples, however, without being limited to the embodiments described in the Examples.

### EXAMPLES

Herein, the weight average molecular weight, unless otherwise indicated, was measured by Gel Permeation Chromatography (GPC) against polystyrene standard in tetrahydrofuran.

In the following description, the part and percentage values are in wt. %, unless otherwise specified.

Following materials were used in preparation processes as below.
AAEMA, 3-oxo-butanoicaci2-[(2-methyl-1-oxo-2-propenyl)oxy]ethylester, 100%, Eastman
EC302, Baxxdour EC302 100%, BASF,
P25, polytriethanolamine, 25%, Polystar 25, BASF
AAEA, 2-acetoacetoxyethylacrylate, 100%, TCI
Lupasol, Lupasol G20, 20%, BASF
MEO, 2-methylprop-2-enyl 3-oxobutanoate, 100%, BASF
LDBS23, Disponil LDBS23, 23%, BASF
Teric305, TERIC305, 100%, Huntsman
DB45, Calfax DB-45, 45%, Pilot Chemical
AA, acrylic acid, 100%, sinopharm
AM50%, acrylamide, 50%, BASF
MMA, methyl methacrylate, 100%, sinopharm
ST, styrene, 100%, sinopharm
nBA, n-butylacrylate, 100%, sinopharm
NaPS, sodium persulfate, 100%, sinopharm
t-BHP, t-butyl hydroperoxide, 10%, BASF
NaHSO3, sodium bisulfite, 100%, sinopharm
NaOH, sodium hydoxide, 100%, sinopharm

In the present invention, the overall stain were tested according to HG T 4756-2014, the ASTM Scrub was tested according to ASTM D 2486; and the formaldehyde abatement efficiency (AntiFA efficiency) was tested according to GB/T 16129-1995.

### Example 1

0.8 g LDBS23 and 140.33 g DI water were put together into reactor and the temperature was heated up to 90° C. During heating, mixed DI water 236.17 g, Teric305 4.53 g, DB45 4.03 g, Disponil AA 5.91 g, AAEMA 13.76 g, AM50% 4.53 g, MMA 111.8 g, styrene 45.61 g and nBA 277.45 g as a pre-emulsion. When the temperature of reactor was stable at 90° C., pre-emulsion 25.4 g was put into reactor within 1 minute, then 7% NaPS 7.27 g was added in another minute. After 5 minutes, the rest of pre-emulsion and 7% NaPS 11.93 g were added within 175 minutes simultaneously and post polymerization for 30 minutes. After polymerization, 10% t-BHP 7.98 g and 13% NaHSO₃ 10.65 g were added within 120 minutes simultaneously to remove the residual monomer. After removed the residual monomers, cooled down the reactor to room temperature, then added 8% NaOH 25.91 g, EC302 13.76 g and P25 47.62 g (25% solid content) to neutralize the polymer dispersion. Water was used to adjust the final solid content to 50 wt. % and get the final sample for testing. Measured by GPC, the Mw of the Example 1 was around 400,000.

### Example 2-3

Same procedue with Example 1 except that different amount of AAEMA or P25 were added.

### Example 4-5

Same procedue with Example 1 except that AAEA or MEO instead of AAEMA was added.

### Example 6

Same procedue with Example 1 except that Lupasol instead of P25 was added.

### Example 7

Same procedue with Example 1 except that no EC302 was added.

### Comparative Examples 1-6

Same procedure with Example 1 except that AAEMA, EC302 and/or P25 were not added.

The amount of AAEMA (or AAEA or MEO), EC302 and P25 (or Lupasol) used in Examples 1-7 and Comparative Examples 1-6 are listed in Table 4.

TABLE 4

| No. | AAEMA | AAEA | MEO | EC302 | P25 | Lupasol |
|---|---|---|---|---|---|---|
| Example 1 | 13.76 | | | 13.76 | 47.62 | |
| Example 2 | 18.35 | | | 13.76 | 47.62 | |
| Example 3 | 13.76 | | | 13.76 | 18.32 | |
| Example 4 | | 13.76 | | 13.76 | 47.62 | |
| Example 5 | | | 13.76 | 13.76 | 47.62 | |
| Example 6 | 13.76 | | | 13.76 | | 59.55 |
| Example 7 | 13.76 | | | | 47.62 | |
| Comparative Example 1 | 13.76 | | | 13.76 | | |
| Comparative Example 2 | 13.76 | | | | | |
| Comparative Example 3 | | | | 13.76 | 47.62 | |
| Comparative Example 4 | | | | | 47.62 | |
| Comparative Example 5 | | | | 13.76 | | |
| Comparative Example 6 | | | | | | |

The test results of overall stain, ASTM scrub and anti-FA efficiency of Examples 1-7 and Comparative Examples 1-6 are listed in Table 5.

TABLE 5

| | Overall | ASTM | Anti-FA |
|---|---|---|---|
| No. | Stain | Scrub | efficiency |
| Example 1 | 64 | 1025 | 77.7 |
| Example 2 | 62 | 1550 | 89 |
| Example 3 | 63 | 1191 | 79 |
| Example 4 | 63 | 1080 | 76.7 |
| Example 5 | 64 | 920 | 78.2 |
| Example 6 | 65 | 900 | 82 |
| Example 7 | 64 | 919 | 73.5 |
| Comparative Example 1 | 55 | 1231 | 81.3 |
| Comparative Example 2 | 55 | 1001 | 43.6 |
| Comparative Example 3 | 60 | 702 | 32.9 |
| Comparative Example 4 | 67 | 602 | 34 |
| Comparative Example 5 | 55 | 863 | 33.6 |
| Comparative Example 6 | 59 | 578 | 34.7 |

1.-17. (canceled)

18. A coating composition comprises:
a) binder containing polymer and/or copolymer of at least one acetoacetyl functional ethylenically unsaturated monomer,
b) at least one polyalkylenimines and/or polyetheramine polyol; and
c) optionally, at least one polyether amine.

19. The coating composition according to claim 18, wherein the at least one acetoacetyl functional ethylenically unsaturated monomer is of formula (I) or formula (II) 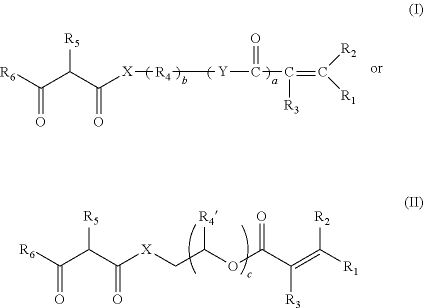
wherein
R₁ is H or C₁₋₁₀-alkyl;
R₂ is H, C₁₋₁₀-alkyl or phenyl which is optionally substituted with at least one of C₁₋₁₀-alkyl, F, Cl, Br, I, CN, hydroxyl and C₁₋₁₀-alkoxy groups;
R₃ is H, C₁₋₁₀-alkyl or phenyl which is optionally substituted with at least one of C₁₋₁₀-alkyl, F, Cl, Br, I, CN, hydroxyl and C₁₋₁₀-alkoxy groups;
R₄ is C₁₋₁₀-alkylene or phenylene;
R₅ is H, C₁₋₁₀-alkyl or phenyl which is optionally substituted with at least one of C₁₋₁₀-alkyl, F, Cl, Br, I, CN, hydroxyl and C₁₋₁₀-alkoxy groups;
R₆ is C₁₋₁₀-alkyl;
R₄′ is H or C₁₋₄-alkyl;
X and Y are independently O or N;
a and b are independently 0 or 1, which are not simultaneously zero; and
c is a number in the range of 2 to 10.

20. The coating composition according to claim 19, wherein R₁, R₂ and R₃ in formula (I) are, independently from each other, selected from H and C₁₋₄-alkyl=; R₄ is C₁₋₄-alkylene-; R₅ is selected from H and methyl=; R₆ is selected from methyl, ethyl and propyl; X is O or N; Y is O; and a and b are independently 0 or 1, which are not simultaneously zero.

21. The coating composition according to claim 19, wherein R₁, R₂ and R₃ in formula (I) are, independently from each other, selected from H and methyl; R₄ is methylene or ethylene; R₅ is H; R₆ is methyl; X is O or N; a is 0; and b is 1.

22. The coating composition according to claim 19, wherein R₁, R₂ and R₃ in formula (I) are, independently from each other, selected from H and methyl; R₄ is methylene or ethylene; R₅ is H; R₆ is methyl; X is O or N; Y is O; and both a and b are 1.

23. The coating composition according to claim 19, wherein R₁, R₂ and R₃ in formula (II) are, independently from each other, selected from H and C₁₋₄-alkyl; R₅ is selected from H and methyl; R₆ is selected from methyl, ethyl and propyl; X is O or N; R₄′ is selected from H, methyl and ethyl; and c is 2, 3, 4, 5, 6, 7 or 8.

24. The coating composition according to claim 19, wherein R₁, R₂ and R₃ in formula (II) are, independently from each other, selected from H and methyl; R₅ is H; R₆ is methyl; R₄′ is H or methyl; X is O or N; and c is 2, 3, 4, 5, 6, 7 or 8.

25. The coating composition according to claim 18, wherein the at least one acetoacetyl functional ethylenically unsaturated monomer is selected from compounds of formula:

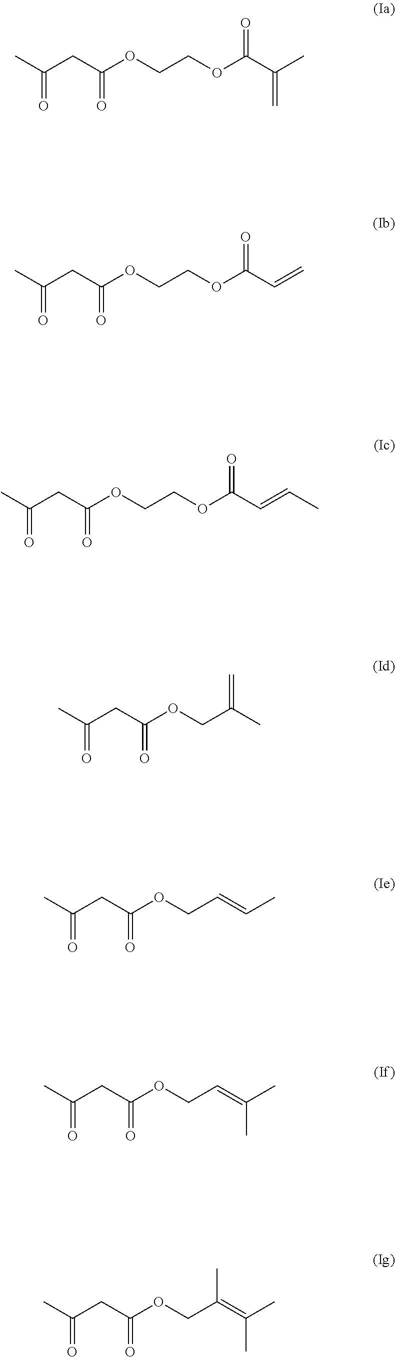

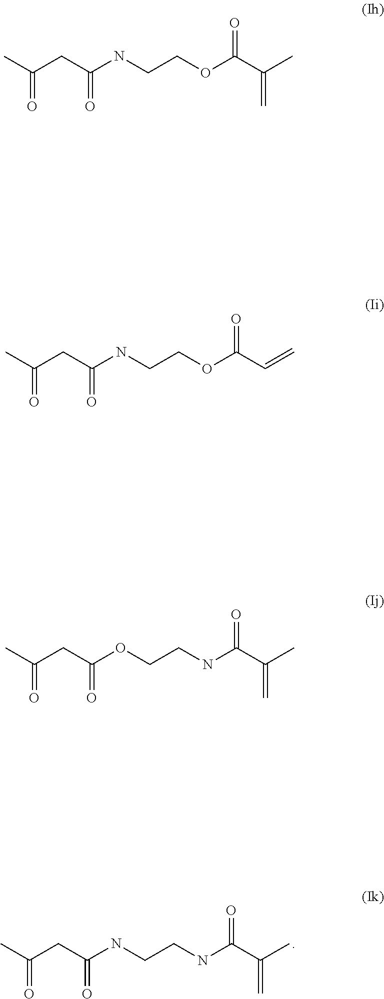

26. The coating composition according to claim 18, wherein the polymer and/or copolymer of at least one acetoacetyl functional ethylenically unsaturated monomer has a weight-average molecular weight in the range of 5,000 to 3,000,000 g/mol.

27. The coating composition according to claim 18, wherein the polyalkylenimine is selected from the group consisting of polyethylenimine and/or polypropylenimine, and the polyalkylenimine having a weight average molecular weight in the range of 100 to 4,000,000 g/mol.

28. The coating composition according to claim 18, wherein polyetheramine polyol is selected from the group consisting of triethanolamine, tri-n-propanolamine, triisopropanolamine, tri-n-butanolamine, triisobutanolamine.

29. The coating composition according to claim 18, wherein polyetheramine polyol having a weight-average molar weight in the range of 1000 to 200000 g/mol.

30. The coating composition according to claim 18, wherein polyether amines have a weight average molecular weight in the range of 104 to 8,000.

31. The coating composition according to claim 18, wherein
a) the at least one acetoacetyl functional ethylenically unsaturated monomer used to prepare the polymer and/or copolymer thereof is in the amount of 0.1 to 10 wt. %,
b) the at least one of polyalkylenimines and/or polyetheramine polyol is present in the amount of 0.1 to 10 wt. %, and
c) the polyether amine is present in the amount of 0 to 10 wt. %,
based on the total weight of the coating composition.

32. The coating composition according to claim 18, wherein the at least one acetoacetyl functional ethylenically unsaturated monomer is added together with other monomer of alkyd resins, epoxy resins, polyurethanes, vinyl acetate/ethylene copolymers, water glasses during the preparation of copolymers contained in the binder.

33. The coating composition according to claim 18, wherein the composition comprises both polyalkylenimines and polyetheramine polyol.

34. A process for preparing a coating composition according to claim 18 by mixing the components comprised therein.
